(19) United States
(12) Patent Application Publication
(10) Pub. No.: US 2004/0219424 A1
(43) Pub. Date: Nov. 4, 2004

(54) Non-aqueous electrolyte secondary battery

(76) Inventors: Yoshimi Kanno, Miyagi (JP); Hiroyuki Koseki, Miyagi (JP); Shunji Watanabe, Miyagi (JP); Tsugio Sakai, Miyagi (JP)

Correspondence Address: ADAMS & WILKS, ATTORNEYS AND COUNSELORS AT LAW, 50 BROADWAY, 31st FLOOR, NEW YORK, NY, 10004, US

(21) Appl. No.: 10/766,589

(22) Filed: Jan. 28, 2004

(30) Foreign Application Priority Data
Feb. 13, 2003 (JP) 2003-034601

(51) Int. Cl. H01M 2/16; H01M 4/58; H01M 4/50; H01M 10/40

(52) U.S. Cl. 429/137; 429/246; 429/224; 429/231.1; 429/218.1; 429/231.95; 429/337; 429/338

(57) ABSTRACT

Heat in a reflow soldering may cause a reaction between the electrolyte liquid and the positive or negative pole active material to result in a rapid inflation or a burst in a battery. A non-aqueous electrolyte secondary battery of a high capacity adaptable to reflow soldering can be produced by employing a positive pole active material or a negative pole active material constituted of particles coated with an oil repellent material.

### BACKGROUND OF THE INVENTION

1. Field of the Invention

The present invention relates to a heat-resistant non-aqueous electrolyte secondary battery adaptable to reflow soldering, among non-aqueous electrolyte secondary battery of coin (button) type employing a substance capable of adsorbing and releasing lithium as an active material of negative and positive poles and also employing a non-aqueous electrolyte showing a lithium ion conductivity.

2. Description of Related Art

A non-aqueous electrolyte secondary battery of coin (button) type has features of a high energy density and a light weight, and is therefore increasingly utilized as a back-up power source for equipment. Prior coin (button) type non-aqueous electrolyte secondary battery often employs a lithium-containing manganese oxide of a 3V class in the positive pole, thereby ensuring a high capacity and a satisfactory cycling property. In such secondary battery, a quality of a gasket for maintaining an air tightness, a liquid tightness and an insulation between a positive pole canister and a negative pole canister of the battery is extremely important. For the material of the gasket, there has been employed polypropylene, which has satisfactory chemical resistance, elasticity and creep resistance, shows satisfactory moldability enabling injection molding and is inexpensive.

In case of utilizing a secondary battery as a memory back-up power source, it is usually welded with a soldering terminal and is then soldered, together with a memory device, on a printed wiring board. The soldering on the printed wiring board has been executed with a soldering iron, however, with a progress in compactization or higher functionality of equipment, it has become necessary to a larger number of electronic components within a same area of the printed wiring board, and it has become difficult to secure a gap for inserting the soldering iron. Also an automation has been requested for the soldering operation, for the purpose of cost reduction.

For this reason, there is being employed a method of coating a solder cream or the like in an area to be soldered on a printed wiring board and placing a component on such coated part, or supplying a small solder ball to an area to be soldered, after a component is placed thereon, and passing the printed wiring board bearing the component through an oven of an atmosphere of a high temperature so selected that the area to be soldered becomes equal to or higher than a melting point of the solder, for example 220 to 260° C. (such method being hereinafter called reflow soldering). However, in a coin (button) type non-aqueous electrolyte secondary battery utilizing a positive or negative pole active material, for which the heat resistance is not considered, there is encountered a drawback that the function of the battery is damaged by such reflow soldering process.

In a coin (button) type non-aqueous electrolyte secondary battery, a molybdenum oxide is employed as a positive pole active material in order that the function of the battery is not damaged -by reflow soldering (for example, Patent document 1).

On the other hand, among inventions for coating a surface of particles of a positive or negative pole active material for improving battery characteristics, there are known a technology of coating the positive pole active material (for example Patent document 2), a technology of coating the surface of a positive pole active material or a negative pole active material with a lithium conductive polymer (for example Patent document 3), and a technology of coating carbon as a negative pole active material with a metal (for example Patent document 4).

Patent document 1: JP-A No. 2002-117841 (page 3)

Patent document 2: JP-A No. 2002-279991 (page 4)

Patent document 3: JP-A No. 2002-373643 (page 3)

Patent document 2: JP-A No. 2002-141069 (page 2)

However, these prior inventions aim at prevention of a deterioration in charge-discharge characteristics of a battery at a large current, or an improvement in cycle lifetime characteristics. In contrast to these prior inventions, an object of the present invention is to prevent a deterioration in battery characteristics at a reflow soldering, and to provide a non-aqueous electrolyte secondary battery adaptable to the reflow soldering.

### SUMMARY OF THE INVENTION

As a result of investigation on a deterioration mechanism of a non-aqueous electrolyte secondary battery at a flow soldering temperature, it is concluded that the deterioration of the battery is caused by a decomposition of a solvent or a solute of the non-aqueous electrolyte by a positive pole active material or a negative pole active material, which is chemically active. Therefore, in order to reduce a direct contact area between the positive pole active material or the negative pole active material, which is chemically active, and the non-aqueous electrolyte, a material showing an oil repellent property is employed in a solvent of the non-aqueous electrolyte to partially or entirely coat the positive pole active material or the negative pole active material, thereby suppressing the deterioration of the battery characteristics at the temperature of reflow soldering and enabling to produce a non-aqueous electrolyte secondary battery allowing reflow soldering.

Also in consideration of a current collecting property of the active material, it is preferable to coat the entire surface of the positive pole active material or the negative pole active material with an oil repellent material and a conductive agent.

In the invention, the kind of the positive pole active material and the negative pole active material is not restricted, however, for obtaining a battery of a high capacity, LiCoO₂, LiNiO₂, LiMn₂O₄, Li₄Mn₅O₁₂, or LiM1₍ₓ₎M2₍₁₋ₓ₎O₂ or LiM1₍ₓ₎M2₍₂₋ₓ₎O₄ is satisfactory (wherein each of M1 and M2 is Co, Ni, Mn or Al and 0<x<1). On the other hand, as the negative pole active material, WO₂, WO₃, SiO, Si or Li—Al alloy is satisfactory for attaining a high capacity.

Also in an electrolyte liquid, a separator and a gasket, constituting the battery, there are found materials having heat resistance and not deteriorating the performance of the battery in a combination with electrodes. In this manner there can be provided a non-aqueous electrolyte secondary battery allowing reflow soldering.

### BRIEF DESCRIPTION OF THE DRAWINGS

FIG. 1 is a cross-sectional view of an active material particle surfacially coated with a thin film of a material showing an oil repellent property to an electrolyte liquid;

FIG. 2 is a cross-sectional view of an active material particle surfacially coated with particles of an oil repellent material;

FIG. 3 is a cross-sectional view of an active material surfacially coated with a conductive agent having a thin film of an oil repellent material on a surface; and

FIG. 4 is a cross-sectional view of a non-aqueous electrolyte secondary battery of the invention.

### DESCRIPTION OF THE PREFERRED EMBODIMENTS

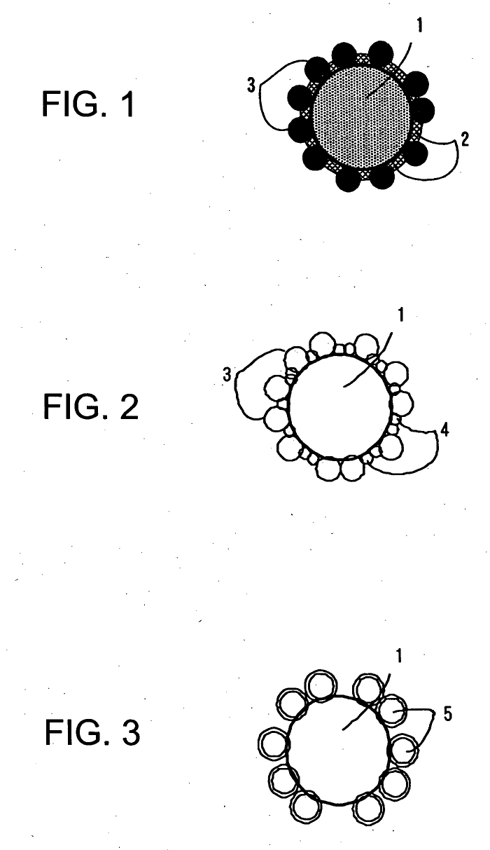

FIG. 1 is a schematic cross-sectional view of an electrode substance of the present invention. As illustrated, a surface of an active material 1 is coated with a thin film 2 of a material showing an oil repellent property to an electrolyte liquid. The active material is further surrounded by a conductive agent 3 for current collection. FIG. 2 shows an embodiment in which an active material 1 is coated with fine power 4 of an oil repellent material. Also FIG. 3 shows an embodiment in which a conductive agent 5, of which surface is coated with an oil repellent material, is provided on a surface of an active material 1. The invention is characterized in reducing a contact area between the active material and the electrolyte liquid, in order to avoid a reaction between the active material and the electrolyte liquid at a heat treatment by reflow soldering. Therefore, for attaining this objective, it is only required that the oil repellent material coats the surface of the active material, and the oil repellent material may have any shape.

For coating the surface of the active material with the oil repellent material, there may be employed a method of spraying a dispersion of the oil repellent material onto the active material, or a method of immersing the active material in a dispersion liquid and then taking out and drying the active material. It is also possible to employ a method of spray drying a liquid, formed by mixing the active material in the dispersion liquid, into a hot air.

In case of forming a film on the active material, it is desirable to form a film as thin as possible in order to maintain an electrical contact resistance between the active material and the conductive agent and a moving resistance for lithium ions at a low level.

In case the oil repellent material is a powder of a particle size smaller than that of the active material, there may also be employed a mechanical coating method. A mechanical milling method of mixing powder of the active material and the oil repellent material with a ball mill or a planet ball mill is effective.

The invention is effective even in case the surface of the active material is not coated with the oil repellent material, by adding the oil repellent material in an ordinary mixing of the active material, a conductive agent, a binder, a releasing agent etc. since the opportunity of direct contact between the active material and the electrolyte liquid is decreased. In such case, an amount of addition of the oil repellent material has to be determined in consideration of the active material and the electrolyte liquid at the process temperature of the reflow soldering, since the addition of the oil repellent material increases the electrical resistance and the moving resistance of lithium ions.

The invention is effective also in case of coating the conductive agent with the oil repellent material and coating the active material with such conductive agent.

As the oil repellent material, a true polymer is effective in addition to a fluorinated resin such as polytetrafluoroethylene (PTFE) or polyvinylidene fluoride (PVDF). Also an inorganic solid electrolyte not incorporating the electrolyte liquid into the powder particles is effective.

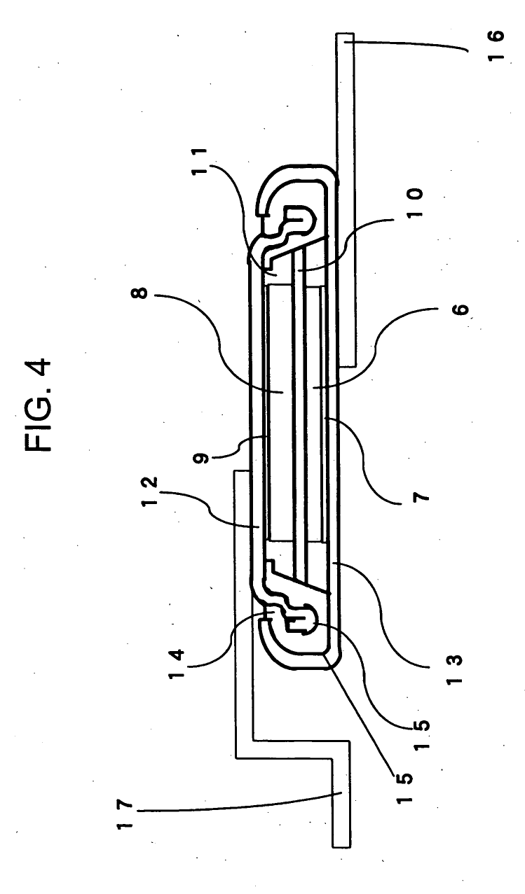

FIG. 4 is a cross-sectional view of a non-aqueous electrolyte secondary battery utilizing the invention. A positive pole is constituted of a positive pole active material 6 and a positive pole current collecting member 7, and a negative pole is constituted of a negative pole active material 8 and a negative pole current collecting member 9. The positive pole and the negative pole are separated by a separator 10. These electrodes and the separator 10 are contained, together with an electrolyte liquid 11, by a negative pole canister 12 and a positive pole canister 13. The electrolyte liquid 11 is formed by a non-aqueous solvent and a supporting salt. The negative pole canister 12 and the positive pole canister 13 are sealed by caulking across a gasket 14. In order to increase the sealing property, a liquid sealant 15 is coated on the negative pole canister 12 and the positive pole canister 13. For electrical connection with external terminals, a positive pole terminal 16 and a negative pole terminal 17 are respectively connected to the positive pole canister 13 and the negative pole canister 12.

As the positive pole active material, LiCoO₂, LiNiO₂, LiMn₂O₄, Li₄Mn₅O₁₂, or LiM1₍ₓ₎M2₍₁₋ₓ₎O₂ or LiM1₍ₓ₎M2₍₂₋ₓ₎O₄ was satisfactory (wherein each of M1 and M2 is Co, Ni, Mn or Al and 0<x<1). In particular, Li₄Mn₅O₁₂, having a high reactivity with the electrolyte liquid, was effective. As the negative pole active material, a lithium alloy such as lithium-aluminum, carbon doped with lithium, a metal oxide (such as SiO, WO₂ or WO₃) doped with lithium, or Si doped with lithium was effective, and a metal oxide having a high reactivity with the electrolyte liquid in a mixed state of the active material and the conductive agent was particularly effective.

For enabling reflow soldering, it was identified that a non-aqueous solvent having a boiling point of 200° C. or higher at the atmospheric pressure was stable at the reflow temperature. The reflow temperature may become as high as about 260° C., but, presumably because the internal pressure of the battery is elevated at such temperature, the battery did not show a burst even in case of employing γ-butyrolactone (γ-BL) with a boiling point of 204° C. at the atmospheric pressure. In consideration of a combination with the positive and negative poles, satisfactory result was obtained by employing one or a plurality selected from propylene carbonate (PC), ethylene carbonate (EC), γ-butyrolactone (γ-BL), methyl tetraglyme, sulforan, and 3-methylsulforan.

In addition to the organic solvents mentioned above, there may also be employed a polymer. As such polymer, there can be employed an ordinarily utilized one, preferably such as polyethylene oxide (PEO), polypropylene oxide, a crosslinked material of polyethylene glycol diacrylate, polyvinylidene fluoride, a crosslinked material of polyphosphazene, a crosslinked material of polypropylene glycol diacrylate, a crosslinked material of polyethylene glycol methyl ether acrylate, a crosslinked material of polypropylene glycol methyl ether acrylate.

Examples of a principal impurity present in the electrolyte liquid (non-aqueous solvent) include water and an organic peroxide (such as a glycol, an alcohol or a carboxylic acid). Such impurity is considered to form an insulating film on the surface of a graphite, thereby increasing an interfacial resistance of an electrode. It may therefore affect the cycle lifetime or a decrease in the capacity. Also a self discharge may increase in a storage at a high temperature (60° C. or higher). Because of these facts, in the electrolyte liquid including the non-aqueous solvent, it is preferable to reduce the impurities as far as possible. More specifically, it is preferable that water is present equal to or less than 50 ppm, and the organic peroxide is present equal to or less than 1000 ppm.

As a supporting salt, a fluorine-containing supporting salt such as lithium hexafluorophosphate (LiPF₆), lithium borofluoride (LiBF₄), lithium trifluorometasulfonate (LiCF₃SO₃), or lithium bisperfluoromethyl sulfonylimide (LiN(CF₃SO₂)) was stable thermally and in electrical characteristics. An amount of dissolution in the non-aqueous solvent is preferably 0.5 to 3.0 mol/l.

A particularly satisfactory result was obtained in case of employing a mixed solvent of ethylene carbonate (EC) and γ-butyrolactone (γ-BL) as the organic solvent, and lithium hexafluorophosphate (LiPF₆) or lithium borofluoride (LiBF₄) as the supporting salt.

As a separator, there is employed an insulating film having a large ionic transmittance and a predetermined mechanical strength. For reflow soldering, glass fibers are employed in most stable manner, but there can also be employed a resin with a thermal deformation temperature of 230° C. or higher such as polyphenylene sulfide, polyethylene terephthalate, polybutylene terephthalate, polyamide or polyimide. The separator has a pore size within a range generally used for batteries. For example, there is employed a pore size of 0.01 to 10 μm. The separator has a thickness within a range generally used for batteries, for example 5 to 300 μm.

A gasket is usually formed by polypropylene or the like, however, in case of reflow soldering, a resin with a thermal deformation temperature of 230° C. or higher such as polyphenylene sulfide, polyethylene terephthalate, polyamide, liquid crystal polymer (LCP), tetrafluoroethylene-perfluoroalkyl vinyl ether copolymer resin (PFA), polyether ether ketone resin (PEEK), or polyether nitrile resin (PEN), did not show a burst or the like at the reflow temperature nor a liquid leakage or the like by a gasket deformation even in a storage after the reflow operation.

In addition, there can also be employed polyether ketone resin (PEK), polyallylate resin, polybutylene terephthalate resin, polycyclohexanedimethylene terephthalate resin, polyethersulfone resin, polyamino bismaleimide resin, polyetherimide resin, or fluorinated resin. It is also experimentally confirmed that an effect similar to that in the present experiment could be obtained with these materials in which glass fibers, mica whiskers, ceramic powder or the like was added with an amount of about 30 wt. % or less.

The gasket can be produced by an injection molding method or a thermal compression method. The injection molding method is most common for forming the gasket. In order to improve a shape or a crystallinity after the injection molding, it is effective to execute a heat treatment in vacuum, in the air or in an inert atmosphere for about 0.5 to 10 hours. However, in case a molding precision is sacrificed for cost reduction, it is necessary to reinforce the air tightness with a liquid sealant.

In the thermal compression molding, a final molded article is obtained by executing a thermal compression molding on a plate material of a thickness larger than that of a molded gasket, as a starting molded article, at a temperature not exceeding the melting point. In general, a molded article of a thermoplastic resin, molded by thermal compression molding of a starting molded article at a temperature not exceeding the melting point, has a property of returning, when heated, to the shape of the starting molded article. In case of a prior non-aqueous electrolyte secondary battery, a gap could be generated between the positive pole canister or the negative pole canister (metal) and the gasket (resin), or a sufficient stress for sealing could be lost between the canister and the gasket, however the aforementioned gasket, in case of use in the non-aqueous electrolyte secondary battery, because of an expansion of the gasket by a property thereof in a thermal treatment (such as reflow soldering), prevents formation of a gap between the positive pole canister or negative pole canister (metal) and the gasket (resin) or allows to obtain a sufficient stress between the canister and the gasket. Also such gasket has a property of returning in time to the shape of the original starting molded article, and is effective in a battery not intended for reflow soldering. Particularly in a gasket employing tetrafluoroethylene-perfluoroalkyl vinyl ether copolymer resin (PFA), a compression molded gasket prepared by pressing a sheet-shaped material under heating had a better sealing property in comparison with that prepared by injection molding. More specifically, because PFA has a rubber elasticity and the thermal compression molded article tends to return to a sheet thickness prior to molding at the reflow temperature, in contrast to an injection molded article which tends to return to the sheet thickness prior to the holding, an increase in the internal pressure is realized in the sealed portion to achieve a higher air tightness.

In a coin or button type battery, a liquid sealant constituted of one or a mixture of asphalt pitch, butyl rubber, a fluorinated oil, chlorosulfonated polyethylene, and epoxy resin is employed between the gasket and the positive and negative pole canisters. In case the liquid sealant is colorless, it may be colored to indicate coating thereof. The sealant can be coated for example by an injection of the sealant into the gasket, a coating on the positive pole canister and the negative pole canister, or a dipping of the gasket in a sealant solution.

In case of a coin or button shaped battery, an electrode is formed by compressing a mixture of the positive active material or the negative pole material into a pellet. Also in case of a thin coin or button shape, an electrode may be formed by punching from a sheet-shaped material. A thickness and a diameter of such pellet is determined by a dimension of the battery.

The pellet may be pressed by an ordinarily employed method, however a metal mold pressing method is particularly preferable. A pressing pressure is not particularly limited, but is preferably 0.2 to 5 t/cm². A pressing temperature is preferably from the room temperature to 200° C.

In an electrode mixture, there may be added a conductive agent, a binder or a filler. A kind of the conductive agent is not particularly limited. The conductive agent may be constituted of metal powder, but a carbon-based material is particularly preferable. A carbon-based material is commonly used, and there is employed natural graphite (flake graphite, scale graphite, muddy graphite etc.), artificial graphite, carbon black, channel black, thermal black, furnace black, acetylene black, or carbon fiber. Also as a metal, there is employed metallic powder of copper, nickel, silver etc. or metal fibers. There can also be employed a conductive polymer.

An amount of addition or mixing of carbon is variable depending on an electrical conductivity of the active material and a shape of the electrode and is not particularly restricted, however it is preferably 1 to 50 wt. % in case of the negative pole, particularly preferably 2 to 40 wt. %.

A particle size of carbon is within a range of 0.5 to 50 μm in an average particle size, preferably 0.5 to 15 μm and more preferably 0.5 to 6 μm, in order to achieve an improved contact among the active material and an improved formation of an electron-conducting network, thereby decreasing the active material not contributing to an electrochemical reaction.

A binder is preferably insoluble in the electrolyte liquid, but is not particularly restricted. There is ordinarily employed a polysaccharide, a thermoplastic resin, a thermo-settable resin or a polymer with rubber elasticity such as polyacrylic acid, a neutralized product of polyacrylic acid, polyvinyl alcohol, carboxymethyl cellulose, starch, hydroxypropyl cellulose, regenerated cellulose, diacetyl cellulose, polyvinyl chloride, polyvinylpyrrolidone, tetrafluoroethylene, polyvinylidene fluoride, polyethylene, polypropylene, ethylene-propylene-diene polymer (EPDM), sulfonated EPDM, styrene-butadiene rubber, polybutadiene, fluorinated rubber, polyethylene oxide, polyimide, epoxy resin, or phenolic resin, either singly or in a mixture thereof. An amount of addition of the binder is not particularly limited, but is preferably 1 to 50 wt. %.

A filler can be any fibrous material not causing a chemical change in a completed battery. In the invention, there are employed fibers for example of carbon or glass. An amount of addition of the filler is not particularly restricted, but is preferably 0 to 30 wt. %.

As a current collecting member for the electrode active material, there is preferred a metal plate of a low electrical resistance. For example, for the positive pole, there is employed stainless steel, nickel, aluminum, titanium tungsten, gold, platinum, sintered carbon, or aluminum or stainless steel surfacially treated with carbon, nickel, titanium or silver. Among the stainless steel, a dual-phase stainless steel is effective against corrosion. In case of a coin- or button-shaped battery, an external side of the electrode may be subjected to a nickel plating. Such process may be executed by wet plating, dry plating, CVD, PVD, pressed cladding or coating.

For the positive pole, there is employed stainless steel, nickel, copper, titanium, aluminum, tungsten, gold, platinum, sintered carbon, or copper or stainless steel surfacially treated with carbon, nickel, titanium or silver, or an Al—Cd alloy. Such treating may be executed by wet plating, dry plating, CVD, PVD, pressed cladding or coating.

On the positive and negative pole canisters constituting the current collecting members for the electrode active materials, terminals are welded for making a contact with a printed wiring board. As a material for the terminal, there is principally-employed stainless steel or iron, with nickel plating, gold plating or solder plating. A welding to the canister is achieved by resistance welding, or laser welding.

It is also possible to fix the electrode active material and the current collecting member by a conductive adhesive. As a conductive adhesive, there can be employed a resin dissolved in a solvent and added with powder or fibers of carbon or a metal, or a solution of a conductive polymer.

In case of a pellet-shaped electrode, the electrode is fixed by a coating between the current collecting member and the electrode pellet. The conductive adhesive in such case often contains a thermo-settable resin.

The non-aqueous electrolyte secondary battery of the invention is not limited in an application, however it is used for example as a back-up power source for a mobile telephone, a pager etc. or a power source of a wrist watch having a power generating function.

The battery of the invention is preferably assembled in an atmosphere free from moisture or an inert gas atmosphere. It is also preferable that components to be assembled are dried in advance. For drying or dehydrating a pellet, a sheet and other components, there can be utilized an ordinarily employed method. It is particularly preferable to employ hot air, vacuum, infrared light, far infrared light, electron beam or low-humidity air, either singly or in combination. A temperature is preferably within a range of 80 to 350° C., particularly preferably within a range of 100 to 250° C. A water content is preferably 2000 ppm or less in an entire battery, and is preferably 50 ppm or less in each of a positive pole mixture, a negative pole mixture and an electrolyte, in order to improve a charge-discharge cycle property.

A heating of the pellet itself is particularly effective, and is preferably within a range of 180 to 280° C. The heating is advantageously executed for a period of 1 hour or longer, and there may be selected an atmosphere of vacuum air, the air or an inert gas. A heating temperature has to be determined, taking not less than a temperature of reflow soldering as a reference and in consideration of the strength of the organic binder. By heating each component at or above the temperature of reflow soldering prior to assembling, the battery does not easily cause a rapid reaction in case it is exposed to the temperature of reflow soldering or a higher temperature. Also a heating improves impregnation of the electrolyte liquid into the pellet, and is very advantageous in improving the battery characteristics in the invention utilizing an electrolyte liquid of a high melting point and a high viscosity.

In the following, the present invention will be clarified further by examples.

### EXAMPLES

### Example 1

A powder of Li₄Mn₅O₁₂ was employed as the positive pole active material. A PTFE dispersion liquid was sprayed and dried on the Li₄Mn₅O₁₂ powder. For such powder material, there were employed graphite as a conductive agent and polyacrylic acid as a binder with a weight ratio of precipitate:graphite:polyacrylic acid=90:7:3 to obtain a positive pole mixture, and 5 mg of such positive pole mixture was press molded into a pellet of a diameter of 2.4 mm under a pressure of 2 ton/cm². Then thus obtained molded member of the positive pole active material was adhered to a positive pole canister, utilizing a positive pole current collecting member constituted of a conductive resinous adhesive containing carbon, thereby obtaining an integral unit (positive pole unit), which was then dried by heating under a reduced pressure for 8 hours at 250° C.

SiO was employed as the negative pole active material. In such SiO powder, graphite as a conductive agent and polyacrylic acid as a binder were mixed with a weight ratio 45:40:15 to obtain a molded member of the negative pole active material. 2.6 mg of the mixture of SiO powder and polyacrylic acid was press molded into a pellet of a diameter of 2.4 mm under a pressure of 2 ton/cm². Then thus obtained molded member of the negative pole active material was adhered to a negative pole canister, utilizing a negative pole current collecting member constituted of a conductive resinous adhesive containing carbon as a conductive filler, thereby obtaining an integral unit (negative pole unit), which was then dried by heating under a reduced pressure for 8 hours at 250° C. Then, on the pellet, a lithium foil punched with a diameter of 2 mm and a thickness of 0.22 mm was pressed on to obtain a laminated electrode of lithium-negative pole pellet.

A glass fiber non-woven cloth of a thickness of 0.2 mm was punched with a diameter of 3 mm after drying to obtain a separator. A gasket was constituted of PPS. An electrolyte liquid was dissolving lithium borofluoride (LiBF₄) in an amount of 1 mol/l in a mixed solvent of ethylene carbonate (EC) and γ-butyrolactone (γ-BL) in a volme ratio of 1:1, and was charged in an amount of 6 μL in a battery canister. The positive pole unit and the negative pole unit were superposed and sealed by caulking to obtain a battery.

### Comparative Example 1

As a Comparative Example, a battery was prepared in the same manner as in Example 1, employing Li₄Mn₅O₁₂ not sprayed with the PTFE dispersion as the positive pole active material and SiO as the negative pole active material.

### Comparative Example 2

In Comparative Example 2, a battery was prepared in the same manner as in Example 1, except that a solvent for the electrolyte liquid was constituted of propylene carbonate (PC), ethylene carbonate (EC) and dimethyl ether (DME) in a volume ratio of 1:1:1.

In order to investigate whether the battery can withstand the reflow temperature, a reflow test was executed under conditions of a preliminary heating for 10 minutes at 180° C. and a heating for 1 minute at 250° C., on 10 units of each of thus prepared batteries. A sample after the heating was subjected to a measurement of height for checking an inflation, a measurement of an internal resistance, and a measurement of cycle characteristics. The height was measured with a dial gauge. The internal resistance was measured by an AC method (1 kHz). In the cycle characteristics, there were employed charge-discharge conditions of a constant current and a constant voltage, with a charging executed with a maximum current of 0.05 mA, a constant voltage of 3.3 V and a charging time of 30 hours, and with a discharging executed with a constant current of 0.025 mA and a terminal voltage of 1.8 V. A superdischarge cycle was executed with a terminal voltage of 0 V.

Results are shown in Table 1.

Table 1

In Table 1, “++” indicates a satisfactory result; “+” indicates a practically acceptable result; “±” indicates a result with certain drawbacks such as a slight inflation of the battery canister or a deterioration in the battery characteristics; and “−” indicates a practically unacceptable level because of drawbacks in the characteristics.

As will be apparent from results of reflow characteristics and cycle characteristics of Example 1 and Comparative Example 1, the reflow heat resistance of the battery is significantly improved by the present invention. In the battery of Comparative Example 1, a gas generation is presumably generated by a reaction of the positive pole active material and the electrolyte liquid, since the battery of Comparative Example 1 showed an inflation of the battery and a significant increase in the internal resistance by the reflow operation. Because of this deterioration, the battery did not provide the cycle characteristics. On the other hand, Example 1 showed an evident improvement in the reflow heat resistance by the coating of the positive pole active material with the oil repellent material, while employing battery components same as in Comparative Example 1.

### Example 2

In the present example, a battery was prepared by coating the positive pole active material and the negative pole active material with the oil repellent material in a same manner as in Example 1.

As shown in Table 1, in this battery system, an effect of coating the negative pole active material with the oil repellent material is limited because of a large deterioration in the positive pole. Also the coating of the negative pole increased the initial internal resistance in comparison with Example 1 in which the positive pole only was coated. However, in the cycle characteristics with a terminal voltage of 1.8 V, there was observed a capacity larger by about 10% than in Example 1, whereby it was confirmed that the present invention is not limited to the positive pole or the negative pole.

### Example 3

This example is different from Example 1 in the coating method of the oil repellent material, and powder of the positive pole active material was charged in a PTFE dispersion and was then dried.

As shown in Table 1, an improvement in the reflow heat resistance was observed also in this method, however an increase in the internal resistance was larger than in Example 1 and a battery capacity in the cycle characteristics was smaller than in Example 1.

### Examples 4 to 6

Example 4 employed PVDF as the oil repellent material. Example 5 employed PEEK for the gasket and PPS for the separator. Example 6 employed LiCoO₂ as the positive pole active material. As shown in Table 1, a reflow heat resistance was observed regardless of the kind of the oil repellent material, the kind of the gasket resin and the kind of the electrode materials, indicating the effectiveness of the invention.

As explained in the foregoing, the present invention covers the positive pole active material or the negative pole active material with an oil repellent material to the electrolyte liquid, thereby enabling to provide a non-aqueous electrolyte secondary battery adaptable to reflow soldering, which has been considered difficult to realize.

TABLE 1

| | | | | | | | | | | Reflow | | | |
|---|---|---|---|---|---|---|---|---|---|---|---|---|---|
| | | | | | | | | | | Character- | | | |
| | | | | | | | | | | istics | | | |
| | | | | Negative Pole Mixture | | | | | | | Inter | | |
| | Positive Pole Mixture | | | | | Addition | | | | | nal | Cycle | |
| | | | Addition | | | Method | | | | | Re- | Characteristics | |
| | | Oil | Method of Oil | | Oil | of Oil | | | | | sis- | | Super- |
| | Active | Repellent | Repellent | Active | Repellent | Repellent | Electro- | | | Infla- | tance | 1.8 V | dis- |
| | Material | Material | Material | Material | Material | Material | lyte | Gasket | Separator | tion | Ω | Cut | charge |
| Exam- | Li₄Mn₅O₁₂ | PTFE | The dispersion | SiO | none | — | GBL/EC | PPS | Glass | ++ | ++ | ++ | + |
| ple 1 | | | liquid is | | | | | | Fiber | | | | |
| | | | sprayed on the | | | | | | | | | | |
| | | | active | | | | | | | | | | |
| | | | material | | | | | | | | | | |
| | | | powder | | | | | | | | | | |
| Exam- | Li₄Mn₅O₁₂ | PTFE | The dispersion | SiO | PTFE | The | GBL/EC | PPS | Glass | ++ | + | ++ | + |
| ple 2 | | | liquid is | | | dispersion | | | Fiber | | | | |
| | | | sprayed on the | | | liquid is | | | | | | | |
| | | | active | | | sprayed on | | | | | | | |
| | | | material | | | the active | | | | | | | |
| | | | powder | | | material | | | | | | | |
| | | | | | | powder | | | | | | | |
| Exam- | Li₄Mn₅O₁₂ | PTFE | The active | SiO | None | — | GBL/EC | PPS | Glass | ++ | + | ++ | + |
| ple 3 | | | material | | | | | | Fiber | | | | |
| | | | powder is | | | | | | | | | | |
| | | | charged in the | | | | | | | | | | |
| | | | dispersion | | | | | | | | | | |
| | | | liquid and then | | | | | | | | | | |
| | | | dried | | | | | | | | | | |
| Exam- | Li₄Mn₅O₁₂ | PVDF | The active | SiO | None | — | GBL/EC | PPS | Glass | ++ | + | + | + |
| ple 4 | | | material | | | | | | Fiber | | | | |
| | | | powder and the | | | | | | | | | | |
| | | | PVDF fine | | | | | | | | | | |
| | | | powder | | | | | | | | | | |
| Exam- | Li₄Mn₅O₁₂ | PTFE | The dispersion | SiO | None | — | GBL/EC | PEEK | PPS | ++ | V | ++ | + |
| ple 5 | | | liquid is | | | | | | | | | | |
| | | | sprayed on the | | | | | | | | | | |
| | | | active | | | | | | | | | | |
| | | | material | | | | | | | | | | |
| | | | powder | | | | | | | | | | |
| Exam- | LiCoO₂ | PTFE | The dispersion | Li-Al | None | — | GBL/EC | PPS | PPS | ++ | ++ | ++ | ± |
| ple 6 | | | liquid is | | | | | | | | | | |
| | | | sprayed on the | | | | | | | | | | |
| | | | active | | | | | | | | | | |
| | | | material | | | | | | | | | | |
| | | | powder | | | | | | | | | | |
| Compa- | Li₄Mn₅O₁₂ | None | — | SiO | None | — | GBL/EC | PPS | Glass | − | − | − | − |
| rative | | | | | | | | | Fiber | | | | |
| Exam- | | | | | | | | | | | | | |
| ple 1 | | | | | | | | | | | | | |

What is claimed is:

1. A non-aqueous electrolyte secondary battery comprising a positive pole, a negative pole, an electrolyte liquid constituted of a non-aqueous solvent and a supporting salt, a separating for separating said positive and said negative pole, and a gasket, wherein a surface of at least either of an active material of said positive pole and an active material of said negative pole is coated with an oil repellent material.

2. A non-aqueous electrolyte secondary battery according to claim 1, wherein said oil repellent material is powder.

3. A non-aqueous electrolyte secondary battery according to claim 1, wherein said oil repellent material is a fluorinated resin.

4. A non-aqueous electrolyte secondary battery according to claim 1, wherein said oil repellent material is an oil repellent conductive agent.

5. A non-aqueous electrolyte secondary battery according to claim 1, wherein said positive pole active material is a lithium-containing manganese oxide.

6. A non-aqueous electrolyte secondary battery according to claim 5, wherein said lithium-containing manganese oxide is Li₄Mn₅O₁₂.

7. A non-aqueous electrolyte secondary battery according to claim 1, wherein said negative pole active material is at least an active material selected from SiO, Si, WO₂, WO₃ and a Li—Al alloy.

8. A non-aqueous electrolyte secondary battery according to claim 1, wherein said non-aqueous solvent has a boiling point of 200° C. or higher at the atmospheric pressure, said supporting salt contains fluorine, said separator is formed by glass fibers or by a resin with a thermal deformation temperature of 230° C. or higher, and said gasket is formed by a resin with a thermal deformation temperature of 230° C. or higher.

9. A non-aqueous electrolyte secondary battery according to claim 8, wherein said non-aqueous solvent having a boiling point of 200° C. or higher at the atmospheric pressure is a single compound or composite compounds selected from ethylene carbonate (EC) and γ-butyrolactone (γ-BL), said supporting salt is a single compound or composite compounds selected from lithium hexafluorophosphate (LiPF₆) and lithium borofluoride (LiBF₄), and a resin constituting said gasket is polyphenylene sulfide (PPS), liquid crystal polymer (LCP), polyether ether ketone resin (PEEK), polyether nitrile resin (PEN), or tetrafluoroethylene-perfluoroalkyl vinyl ether copolymer resin (PFA).
